(19) United States
(12) Patent Application Publication
(10) Pub. No.: US 2020/0334920 A1
(43) Pub. Date: Oct. 22, 2020

(54) GEO BOUNDED DYNAMIC DATA COLLECTION FOR ROAD TOLLING AND ROAD USAGE MONITORING

(71) Applicant: GENERAL MOTORS LLC, Detroit, MI (US)

(72) Inventors: Stephen M. London, West Bloomfield, MI (US); Alexander X. Cermak, Grosse Pointe Woods, MI (US); Anvesh Singireddy, Farmington Hills, MI (US); Brian N. Hoglund, Northville, MI (US); Thomas Gregg DeMaria, Oakland Township, MI (US)

(73) Assignee: GENERAL MOTORS LLC, Detroit, MI (US)

(21) Appl. No.: 16/387,008

(22) Filed: Apr. 17, 2019

(51) Int. Cl. G07B 15/06; G06Q 30/02; G08G 1/01

(52) U.S. Cl. CPC G07B 15/063; G06Q 2240/00; G08G 1/0116; G06Q 30/0284

(57) ABSTRACT

In various embodiments, methods, vehicle systems, and communication systems are provided, that include: obtaining location data for a vehicle while the vehicle is travelling, via a positioning system built into the vehicle; determining when the vehicle has entered a geo-fence associated with a regulated roadway, via a processor built into the vehicle; monitoring the vehicle, using the processor along with the positioning system, one or more sensors built into the vehicle, or both, generating vehicle data, while the vehicle is within the geo-fence, the vehicle data pertaining to a vehicle's usage of, compliance with, or both, of the regulated roadway; determining when the vehicle has exited the geo-fence, via the processor disposed onboard the vehicle; and transmitting the vehicle data, for use in determining a fee associated with the vehicle's travel along the regulated roadway, after the vehicle has exited the geo-fence, via a transceiver disposed onboard the vehicle.

### BACKGROUND

The technical field generally relates to vehicles, and more particularly relates to data collection and usage pertaining to a vehicle being operated on a roadway.

Certain roadways on which vehicles travel have particular regulations (e.g., rules and/or fees) associated with them. For example, vehicles may be charged fees for travelling on certain roads, such as toll roads and/or other roads with road usage charges. By way of additional example, high occupancy vehicle (HOV), or carpool lanes, of certain roadways may have restrictions on vehicles that travel in such lanes (e.g., requiring that at least a specified minimum number of people be present within the vehicle while travelling through such lanes, and/or disallowing driving on a regulated roadway that is designated for parking, and so on). It may be desirable to provide improved methods and systems for collecting and utilizing data for vehicles that travel on regulated roadways, such as toll roads, road usage charge roads, and roads with HOV lanes and/or designated parking areas.

Accordingly, it may be desirable to provide improved methods and systems for collecting and utilizing data for vehicles that travel on regulated roadways, such as toll roads, road usage charge roads, and roads with HOV lanes and/or designated parking areas. Furthermore, other desirable features and characteristics of the present invention will become apparent from the subsequent detailed description of the invention and the appended claims, taken in conjunction with the accompanying drawings and this background of the invention.

### SUMMARY

In accordance with one exemplary embodiment, a method is provided. The method includes: obtaining location data for a vehicle while the vehicle is travelling, via a positioning system built into the vehicle; determining when the vehicle has entered a geo-fence associated with a regulated roadway, via a processor built into the vehicle; monitoring the vehicle, using the processor along with the positioning system, one or more sensors built into the vehicle, or both, generating vehicle data, while the vehicle is within the geo-fence, the vehicle data pertaining to a vehicle's usage of, compliance with, or both, of the regulated roadway; determining when the vehicle has exited the geo-fence, via the processor disposed onboard the vehicle; and transmitting the vehicle data, for use in determining a fee associated with the vehicle's travel along the regulated roadway, after the vehicle has exited the geo-fence, via a transceiver disposed onboard the vehicle.

Also in one embodiment, the positioning system, the one or more sensors, the processor, and the transceiver are built into the vehicle at the time of manufacture of the vehicle.

Also in one embodiment, the regulated roadway includes a toll road.

Also in one embodiment, the step of monitoring the vehicle includes monitoring a distance within the toll road through which the vehicle has travelled, using data from the positioning system.

Also in one embodiment, the step of monitoring the vehicle includes monitoring specific segments and lanes of the toll road through which the vehicle has travelled, using data from the positioning system.

Also in one embodiment, the regulated roadway includes a high occupancy vehicle (HOV) lane; and the step of monitoring the vehicle includes monitoring a number of occupants in the vehicle as the vehicle travels through the HOV lane, using data from the one or more sensors.

Also in one embodiment, the regulated roadway includes road usage charge (RUC) road.

Also in one embodiment, the regulated roadway includes a roadway having a designated parking area.

Also in one embodiment, the method further includes determining a monetary fee associated with the vehicle's travelling through the roadway, based on the vehicle's usage of, compliance with, or both, with respect to the regulated roadway, using the vehicle data, data from one or more other nearby vehicles, or both.

Also in one embodiment, the method further includes: determining a classification for the regulated roadway; and providing a notification, for an occupant inside the vehicle, of the classification of the regulated roadway when the vehicle enters and exits the geo-fence.

In another exemplary embodiment, a vehicle system is provided. The vehicle system includes a positioning system, one or more sensors, a processor, and a transceiver. The positioning system is disposed onboard a vehicle, and is configured to obtain location data for the vehicle while the vehicle is travelling. The one or more sensors are built into the vehicle. The processor is disposed onboard the vehicle, and is configured to: determine when the vehicle has entered a geo-fence associated with a regulated roadway, via a processor disposed onboard the vehicle; monitor the vehicle, using the processor along with the positioning system, the one or more sensors, or both, generating vehicle data, while the vehicle is within the geo-fence, the vehicle data pertaining to a vehicle's usage of, compliance with, or both, of the regulated roadway; determine when the vehicle has exited the geo-fence, via the processor disposed onboard the vehicle; and provide instructions for transmitting the vehicle data, for use in determining a fee associated with the vehicle's travel along the regulated roadway, after the vehicle has exited the geo-fence. The transceiver is built into the vehicle, and is configured to transmit the vehicle data, for use in determining a fee associated with the vehicle's travel along the regulated roadway, after the vehicle has exited the geo-fence, in accordance with the instructions provided by the processor.

Also in one embodiment, the positioning system, the one or more sensors, the processor, and the transceiver are built into the vehicle at the time of manufacture of the vehicle.

Also in one embodiment, the regulated roadway includes a toll road, and the processor is configured to monitor the vehicle by monitoring a distance within the toll road through which the vehicle has travelled, using data from the positioning system.

Also in one embodiment, the regulated roadway includes a toll road, and the processor is configured to monitor the vehicle by monitoring specific segments and lanes of the toll road through which the vehicle has travelled, using data from the positioning system.

Also in one embodiment, the regulated roadway includes a high occupancy vehicle (HOV) lane; and the processor is configured to monitor the vehicle by monitoring a number of occupants in the vehicle as the vehicle travels through the HOV lane, using data from the one or more sensors.

Also in one embodiment, the processor is configured to determine a monetary fee associated with the vehicle's travelling through the roadway, based on the vehicle's usage of, compliance with, or both, with respect to the regulated roadway, using the vehicle data, data from one or more other nearby vehicles, or both.

Also in one embodiment, the processor is configured to: determine a classification for the regulated roadway; and provide a notification, for an occupant inside the vehicle, of the classification of the regulated roadway when the vehicle enters and exits the geo-fence.

In another exemplary embodiment, a communication system is provided that includes a positioning system, one or more sensors, a first processor, a transceiver, and a second processor. The positioning system is disposed onboard a vehicle, and is configured to obtain location data for the vehicle while the vehicle is travelling. The one or more sensors are built into the vehicle. The first processor is disposed onboard the vehicle, and is configured to: determine when the vehicle has entered a geo-fence associated with a regulated roadway, via a processor disposed onboard the vehicle; monitor the vehicle, using the processor along with the positioning system, the one or more sensors, or both, generating vehicle data, while the vehicle is within the geo-fence, the vehicle data pertaining to a vehicle's usage of, compliance with, or both, of the regulated roadway; determine when the vehicle has exited the geo-fence, via the processor disposed onboard the vehicle; and provide instructions for transmitting the vehicle data, for use in determining a fee associated with the vehicle's travel along the regulated roadway, after the vehicle has exited the geo-fence. The transceiver is built into the vehicle, and is configured to transmit the vehicle data, after the vehicle has exited the geo-fence, in accordance with the instructions provided by the processor. The second processor is disposed remote from the vehicle, and is configured to: determine the vehicle's usage, compliance, or both, of the regulated roadway, using the vehicle data; and determine a monetary fee associated with the vehicle's travel along the regulated roadway, based on the vehicle's usage, compliance, or both, of the regulated roadway using the vehicle data.

Also in one embodiment, the regulated roadway includes a toll road; the vehicle data includes specific segments and lanes of the toll road through which the vehicle has travelled, as determined using information from the positioning system; and the second processor is configured to determine the monetary fee based on the specific segments and lanes of the toll road through which the vehicle has travelled.

Also in one embodiment, the regulated roadway includes a high occupancy (HOV) lane; the vehicle data includes a number of occupants in the vehicle, as determined using information from the one or more sensors; and the second processor is configured to determine the monetary fee based on the number of occupants in the vehicle as the vehicle travels through the high occupancy lane.

### BRIEF DESCRIPTION OF THE DRAWINGS

The present disclosure will hereinafter be described in conjunction with the following drawing figures, wherein like numerals denote like elements, and wherein:

FIG. 1 is a functional block diagram of a communications system that includes a vehicle, and that is configured to collect and utilize data for vehicles that travel on a regulated roadway, in accordance with exemplary embodiments;

FIG. 2 is a block diagram of modules of the communications system of FIG. 1, in accordance with exemplary embodiments; and

FIG. 3 is a flowchart of a process for collecting and utilizing data for vehicles that travel on a regulated roadway, and that can be used in connection with the communications system of FIGS. 1 and 2, including the vehicle thereof of FIG. 1 and the modules of FIG. 2, in accordance with exemplary embodiments.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

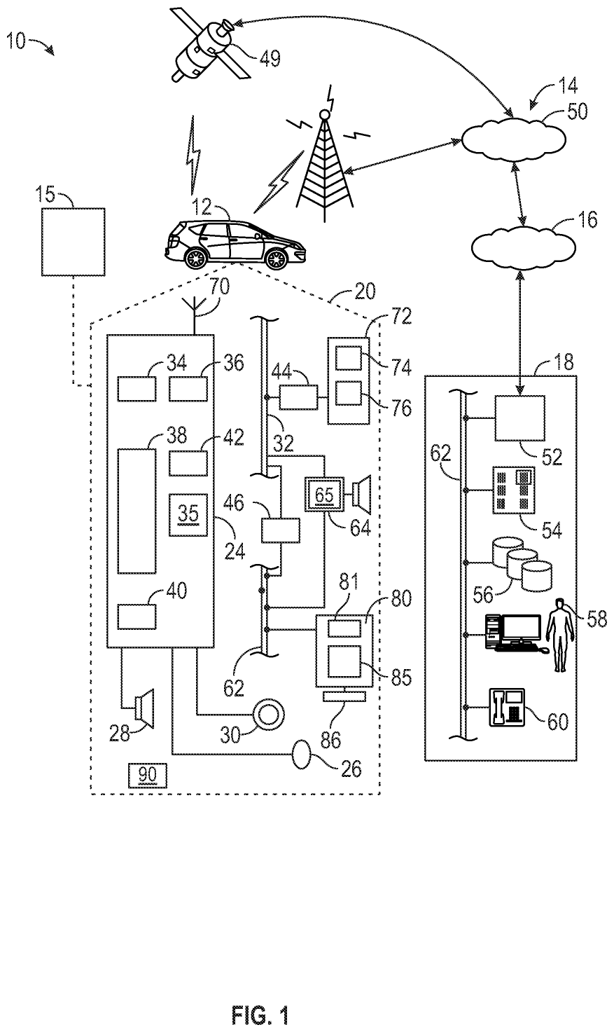

FIG. 1 is a functional block diagram of a communications system 10, in accordance with an exemplary embodiment. As described in greater detail further below, the communications system 10 generally includes a vehicle 12, along with one or more wireless carrier systems 14, one or more land networks 16, and one or more remote servers 18. As described in greater detail further below, in various embodiments, the communications system 10 provides for dynamic data collection from a built-in system within the vehicle 12 with respect to regulated roadways on which the vehicle 12 travels, such as toll roads, road usage charge (RUC) roads (e.g., in certain states that collect a tax on total miles travelled by a vehicle on public roads, RUC roads would include any public roads in that state), high occupancy vehicle (HOV) lanes, and/or roads with designated parking areas.

It should be appreciated that the overall architecture, setup and operation, as well as the individual components of the illustrated system are merely exemplary and that differently configured communications systems may also be utilized to implement the examples of the method disclosed herein. Thus, the following paragraphs, which provide a brief overview of the illustrated communications system 10, are not intended to be limiting.

In various embodiments, each vehicle 12 may be any type of mobile vehicle such as a motorcycle, car, truck, recreational vehicle (RV), boat, plane, farm equipment, or the like, and is equipped with suitable hardware and software that enables it to communicate over communications system 10. As shown in FIG. 1, in various embodiments the vehicle hardware 20 is disposed within a body 19 of the vehicle 12, and includes a telematics unit 24, a microphone 26, a speaker 28, and buttons and/or controls 30 connected to the telematics unit 24. Operatively coupled to the telematics unit 24 is a network connection or vehicle bus 32. In various embodiments, the vehicle 12 has an engine (or motor) 90. Examples of suitable network connections include a controller area network (CAN), a media-oriented system transfer (MOST), a local interconnection network (LIN), an Ethernet, and other appropriate connections such as those that conform with known ISO (International Organization for Standardization), SAE (Society of Automotive Engineers), and/or IEEE (Institute of Electrical and Electronics Engineers) standards and specifications, to name a few.

The telematics unit 24 is an onboard device, embedded within the vehicle 12, that provides a variety of services through its communication with the remote server 18, and generally includes an electronic processing device (processor) 38, one or more types of electronic memory 40, a cellular chipset/component 34, a transceiver 35, a wireless modem 36, a dual mode antenna 70, and a navigation unit containing a GPS chipset/component 42. In one example, the wireless modem 36 includes a computer program and/or set of software routines adapted to be executed within electronic processing device 38. Also in various embodiments, the transceiver 35 is configured to transmit, to one or more remote destinations (e.g., the remote server 18 of FIG. 1), data pertaining to the vehicle 12 (e.g., including roadway segments and lanes in which the vehicle 12 travels as well as a number of occupants in the vehicle 12) as the vehicle 12 travels through regulated roadways (e.g., toll roads, RUC roads, HOV lanes, and roads with designated parking areas).

In various embodiments, the telematics unit 24 is embedded and installed (and built-in) within the vehicle 12 at the time of manufacture. In various embodiments, the telematics unit 24 enables voice and/or data communications over one or more wireless networks (e.g., wireless carrier system 14), and/or via wireless networking, thereby allowing communications with the remote server 18 and/or other vehicles and/or systems.

In various embodiments, the telematics unit 24 may use radio transmissions to establish a voice and/or data channel with the wireless carrier system 14 so that both voice and data transmissions can be sent and received over the voice and/or data channels. Vehicle communications are enabled via the cellular chipset/component 34 for voice communications and the wireless modem 36 for data transmission. Any suitable encoding or modulation technique may be used with the present examples, including digital transmission technologies, such as TDMA (time division multiple access), CDMA (code division multiple access), W-CDMA (wideband CDMA), FDMA (frequency division multiple access), OFDMA (orthogonal frequency division multiple access), and the like. In one embodiment, dual mode antenna 70 services the GPS chipset/component 42 and the cellular chipset/component 34. In various embodiments, the telematics unit 24 utilizes cellular communication according to industry standards, such as LTE, 5G, or the like. In addition, in various embodiments, the telematics unit 24 carries out wireless networking between the vehicle 12 and one or more other network devices, for example using one or more wireless protocols such as one or more IEEE 802.11 protocols, WiMAX, or Bluetooth.

The telematics unit 24 may offer a number of different services for users of the vehicle 12, including providing data pertaining to the vehicle 12 (e.g., including roadway segments and lanes in which the vehicle 12 travels as well as a number of occupants in the vehicle 12) as the vehicle 12 travels through regulated roadways (e.g., toll roads, RUC roads, HOV lanes, and roads with designated parking areas). In various embodiments, the telematics unit 24 obtains data pertaining to the vehicle 12's location (e.g., geographic location, or position) over time from the GPS chipset/component 42.

In addition, in various embodiments, the telematics unit 24 also obtains vehicle-related information from various vehicle sensors 72, connected to various sensor interface modules 44 are operatively connected to the vehicle bus 32. In various embodiments, the vehicle sensors 72 include user input sensors 74 and occupant sensors 76, described below. In various embodiments, the vehicle sensors 72 may also include any number of other sensors, such as by way of example, wheel speed sensors, accelerometers, steering angle sensors, braking system sensors, gyroscopes, magnetometers, emission detection, and/or control sensors, and the like. Example sensor interface modules 44 include powertrain control, climate control, and body control, to name but a few.

In various embodiments, the input sensors 74 are utilized to detect inputs from the user with respect to operation of various vehicle components. For example, in various embodiments, the input sensors 74 detect requests by the user to remotely start the vehicle 12 and/or an environmental control system thereof, and/or requests as to a particular destination for travel for the vehicle 12, and so on. In certain embodiments, the input sensors 74 are part of and/or coupled to an electronic device 15 (e.g., a keyfob, smart phone, or other electronic device) and/or one or more of the hardware components 20 and/or controls 30, and/or to one or more other vehicle modules 80, such as one or more engine control modules 81, display modules 85 (e.g., providing audio and/or visual displays for the user, including notifications of entry and exit of geo-fences of regulated roadways, and/or invoicing of costs pertaining thereto), and/or other control modules that control different functionality for the vehicle 12, that may be connected to one another and to telematics unit 24 via the communications bus 62. For example, in various embodiments, the input sensors 74 may be part of and/or coupled to controls 30 for the electronic device 15 and/or to one or more hardware components 20 and/or various input devices 86 for use with other vehicle modules 80, such as one or more touch screens, push buttons, dials, switches, knobs, levers, or the like.

In various embodiments, the occupant sensors 76 detect occupants inside the vehicle 12, preferably including data representative of how many occupants are inside the vehicle 12 at any particular point in time. In certain embodiments, the occupant sensors 76 comprise weight sensors configured to assess a weight or load on each of a plurality of passenger seats within the vehicle 12. In certain other embodiments, the occupant sensors 76 may detect occupants via one or more other different sensing techniques, such as, by way of example: detecting occupants via one or more image sensors, detection sensors, and/or light-sensitive sensors (e.g., a camera, radar, lidar, and the like) and/or detecting occupants via engagement of occupant apparatus (e.g., occupant seat belts), and so on.

Also in certain embodiments, the telematics unit 24 analyzes the vehicle data received from the GPS chipset/component 42 and the vehicle sensors 72. Also in various embodiments, the telematics unit 24 determines when the vehicle 12 enters and exists a geo-fence of a regulated roadway (e.g., a toll road, RUC road, road having a designated parking area, or HOV lane, as determined using the data from the GPS chipset/component 42) and monitors the vehicle data (including the location of travel of the vehicle 12 and the number of occupants in the vehicle 12) as the vehicle 12 travels through the regulated roadway.

Also in various embodiments, the telematics unit 24 provides the vehicle data including the location of travel of the vehicle 12 and the number of occupants in the vehicle 12) to the remote server 18 for use in determining compliance with costs associated with the regulated roadway (e.g., including toll road costs and/or RUC costs based on travel of the vehicle 12, costs for parking in designated parking areas of roadways, and compliance with requirements of HOV lanes and/or requirements of other regulated roadways). In certain embodiments the telematics unit 24 may also be utilized to determine the costs and compliance themselves, and/or to collect appropriate fees from the operator of the vehicle 12.

In addition, in various embodiments, the telematics unit 24 may also provide other services, such as, by way of example: turn-by-turn directions and other navigation-related services provided in conjunction with the GPS chipset/component 42, emergency assistance services, information requests from the users of the vehicle 12 (e.g., regarding points of interest en route while the vehicle 12 is travelling), and/or infotainment-related services, for example in which music, internet web pages, movies, television programs, videogames, and/or other content are downloaded by an infotainment center 46 that may be part of the telematics unit 24 and/or operatively connected to the telematics unit 24 via vehicle bus 32 and audio bus 22, among various other types of possible services.

With respect to other electronic components utilized in connection with the telematics unit 24, the microphone 26 provides the driver or other vehicle occupant with a means for inputting verbal or other auditory commands, and can be equipped with an embedded voice processing unit utilizing a human/machine interface (HMI) technology known in the art. Conversely, speaker 28 provides audible output to the vehicle occupants and can be either a stand-alone speaker specifically dedicated for use with the telematics unit 24 or can be part of a vehicle audio component 64. In either event, microphone 26 and speaker 28 enable vehicle hardware 20 and remote server 18 to communicate with the occupants through audible speech. The vehicle hardware also includes one or more buttons and/or controls 30 for enabling a vehicle occupant to activate or engage one or more of the vehicle hardware components 20. For example, one of the buttons and/or controls 30 can be an electronic pushbutton used to initiate voice communication with remote server 18 (whether it be a human such as advisor 58 or an automated call response system). In another example, one of the buttons and/or controls 30 can be used to initiate emergency services.

The audio component 64 is operatively connected to the vehicle bus 32 and the audio bus 22. The audio component 64 receives analog information, rendering it as sound, via the audio bus 22. Digital information is received via the vehicle bus 32. The audio component 64 provides amplitude modulated (AM) and frequency modulated (FM) radio, compact disc (CD), digital video disc (DVD), and multimedia functionality independent of the infotainment center 46. Audio component 64 may contain a speaker system, or may utilize speaker 28 via arbitration on vehicle bus 32 and/or audio bus 22. In various embodiments, the audio component 64 includes radio system 65 (which also includes antenna 70, as well as amplifiers, speakers, and the like, in certain embodiments).

The wireless carrier systems 14 may be any number of cellular telephone systems, satellite-based wireless systems, and/or any other suitable wireless systems, for example that transmits signals between the vehicle hardware 20 and land network 16 (and/or, in certain embodiments, that communicate directly with the vehicle 12 and/or the remote server 18). According to certain examples, wireless carrier system 14 may include and/or be coupled to one or more cell towers 48, satellites 49, base stations and/or mobile switching centers (MSCs) 50, as well as any other networking components required to connect the wireless carrier system 14 with land network 16. As appreciated by those skilled in the art, various cell tower/base station/MSC arrangements are possible and could be used with wireless carrier system 14.

The land network 16 can be a conventional land-based telecommunications network that is connected to one or more landline telephones, and that connects wireless carrier system 14 to remote server 18. For example, the land network 16 can include a public switched telephone network (PSTN) and/or an Internet protocol (IP) network, as is appreciated by those skilled in the art. Of course, one or more segments of the land network 16 can be implemented in the form of a standard wired network, a fiber or other optical network, a cable network, other wireless networks such as wireless local networks (WLANs) or networks providing broadband wireless access (BWA), or any combination thereof.

The remote server 18 is designed to provide the vehicle hardware 20 with a number of different system back-end functions and, according to the example shown here, generally includes one or more switches 52, servers 54 (e.g., including one or more processors), databases 56, advisors 58, as well as a variety of other telecommunication/computer equipment 60. These various call center components are suitably coupled to one another via a network connection or bus 62, such as the one previously described in connection with the vehicle hardware 20. Switch 52, which can be a private branch exchange (PBX) switch, routes incoming signals so that voice transmissions are usually sent to either advisor 58 or an automated response system, and data transmissions are passed on to a modem or other piece of telecommunication/computer equipment 60 for demodulation and further signal processing.

The transceivers 35, and/or modem or other telecommunication/computer equipment 60 may include an encoder, as previously explained, and can be connected to various devices such as a server 54 and database 56. In various embodiments, the database 56 of the remote server 18 comprises a computer memory that stores information regarding costs and compliance with the regulated roadway (e.g., including how tolls are calculated for toll roads are calculated, how road usage charges are calculated for RUC roads, how parking charges are calculated for vehicles parked in a designated parking area of a roadway, how compliance is determined for HOV lanes with respect to a minimum number of occupants, and compliance and cost records, data, and invoices for various vehicle 12's and their owners or occupants thereof, and the like). Although the illustrated example has been described as it would be used in conjunction with a remote server 18 that is manned, it will be appreciated that the remote server 18 can be any central or remote facility, manned or unmanned, mobile or fixed, to or from which it is desirable to exchange voice and data.

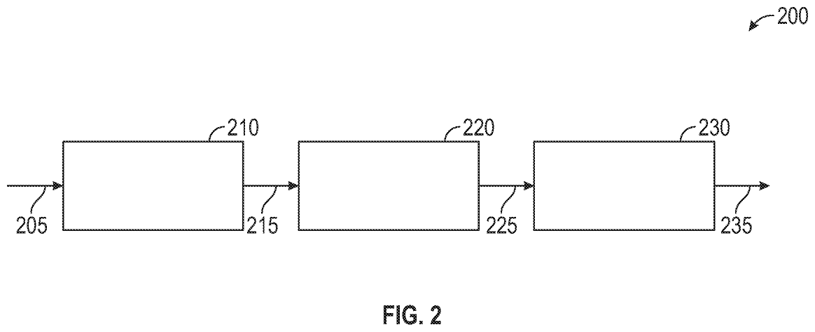

FIG. 2 provides a functional block diagram for modules of the communications system 10 of FIG. 1, in accordance with exemplary embodiments. In various embodiments, each module includes and/or utilizes computer hardware, for example via one or more computer processors and memory. As depicted in FIG. 2, in various embodiments, the communications system 10 generally includes a data module 210, a processing module 220, and a transmitting module 230. In various embodiments, the data module 210, the processing module 220, and the transmitting module 230 are disposed onboard the vehicle 12. In certain embodiments, certain module(s) be disposed, at least in part, as part of the remote server 18 of FIG. 1.

In various embodiments, the data module 210 collects vehicle data via the GPS chipset/component 42 and the sensors 72 of FIG. 1. In various embodiments, the data module 210 utilizes the GPS chipset/component 42 for detecting a location of the vehicle 12 over time. Also in various embodiments, one or more occupant sensors 76 (e.g., one or more weight sensors and/or image sensors, in certain embodiments) detect a number of occupants in the vehicle 12.

In addition, in various embodiments, the data module 210 provides information pertaining to the collected vehicle data (including the location of the vehicle 12 over time and the number of occupants in the vehicle 12) as outputs 215 of the data module 210 for use by the processing module 220, for example as discussed below.

In various embodiments, the processing module 220 utilizes the data from the data module 210 (e.g., the vehicle data including the location of the vehicle 12 over time and the number of occupants in the vehicle 12) as inputs 215 for the processing module 220, and controls instructions for remote commands for the vehicle 12. Specifically, in various embodiments, the processing module 220 determines, using the vehicle 12 location information, when the vehicle 12 enters and exits a geo-fence pertaining to a regulated roadway (e.g., a toll road, RUC road, road having a designated parking area, and/or HOV lane). Also in certain embodiments, the processing module 220 determines which segments and lanes of the regulated roadway the vehicle 12 travels through based on continued monitoring of the location information as the vehicle 12 remains within the geo-fence. In addition, in certain embodiments, the processing module 220 makes one or more determinations regarding the number of occupants in the vehicle 12 based on raw data provided by the occupant sensors 76. Moreover, in various embodiments, the processing module 220 makes determinations regarding compliance and costs for the vehicle 12 with respect to the regulated roadway (e.g., in certain embodiments, including a toll fee and/or RUC fees accrued by the vehicle 12 while travelling through the geo-fence, a parking fee accrued by the vehicle 12 for parking in a designated parking area, and/or an assessment as to whether or not the vehicle 12 has complied with minim occupant requirements for an HOV lane and/or any other requirements for the regulated roadway), and so on.

In addition, in various embodiments, the data module 210 provides instructions 225 to the transmitting module 230. Specifically, in various embodiments, the transmitting module 230 implements the instructions 225 in providing transmissions 235 to one or more remote locations (such as the remote server 18 of FIG. 1) regarding the vehicle data and/or determinations pertaining thereto. For example, in certain embodiments, the transmissions 235 include data and/or determinations pertaining to the road segments and lanes through which the vehicle has travelled, along with compliance and costs for the vehicle 12 with respect to the regulated roadway (e.g., in certain embodiments, including a toll fee accrued by the vehicle 12 while travelling through the toll road, a road usage fee accrued by the vehicle 12 while travelling through an RUC road, a parking fee accrued by the vehicle 12 while parking in a designated parking area, and/or an assessment as to whether or not the vehicle 12 has complied with minim occupant requirements for an HOV lane and/or any other requirements for the regulated roadway), for use in invoicing, collecting fees, and/or taking corrective action with respect to the vehicle 12 as appropriate.

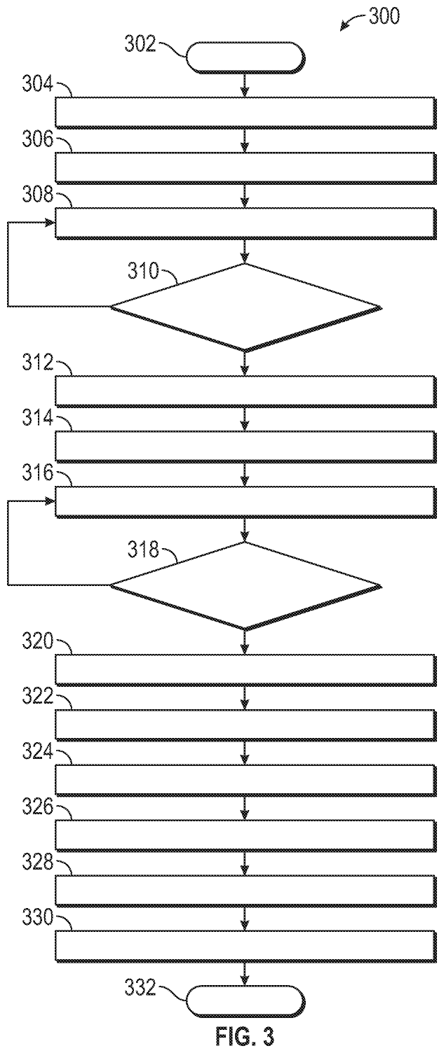

FIG. 3 is a flowchart of a process 300 for collecting and utilizing data for vehicles that travel on a regulated roadway, in accordance with exemplary embodiments. In various embodiments, the process 300 can be used in connection with the communications system 10 of FIG. 1, including the vehicle 12 and the remote server 18 thereof, the components thereof of FIG. 1, and the modules thereof of FIG. 2, in accordance with exemplary embodiments.

As depicted in FIG. 3, in various embodiments the process 300 begins at step 302. In certain embodiments, the process 300 begins when the vehicle 12 is turned on and/or begins travelling, and/or when one or more users of the vehicle 12 approach or enter the vehicle 12, when a user request has been received, and/or when a user request and/or use of the vehicle 12 is expected. In certain embodiments, the steps of the process 300 are performed continuously during operation of the vehicle 12.

In various embodiments, vehicle data is obtained at 304. In certain embodiments, the obtained data includes various data pertaining to operation of the vehicle 12, including any inputs from the user (e.g., as to a requested destination, climate control, infotainment, and so on), and including vehicle occupant data and location data as described below in connection with 306 and 308, respectively. In certain data, vehicle data is also obtained from other nearby vehicles. For example, in certain embodiments, in which estimates may be desired for congestion as a basis for charging road fees, data may also be obtained from other vehicles entering a geo-fence as an input for determining the monetary fee (e.g., for evaluating peak versus non-peak use of the roadways as they pertain to the number of vehicles and thereby resulting congestion and/or pollution, and so on).

Specifically, in various embodiments, vehicle occupant data is obtained at 306. In various embodiments, the vehicle occupant data includes information as to how many occupants are disposed inside the vehicle 12. In various embodiments, the vehicle occupant data is obtained via one or more occupant sensors 76 of FIG. 1. For example, in certain embodiments, the vehicle occupant data is obtained via one or more weight sensors configured to assess a weight or load on each of a plurality of passenger seats within the vehicle 12. In certain other embodiments, the vehicle occupant data is obtained via one or more other different types of sensors, such as, by way of example: detecting occupants via one or more image sensors, detection sensors, and/or light-sensitive sensors (e.g., a camera, radar, lidar, and the like) and/or detecting occupants via engagement of occupant apparatus (e.g., occupant seat belts), and so on. In certain embodiments, the vehicle occupant data of 306 comprises raw data from the occupant sensors 76 for a subsequent determination as to the number of occupants inside the vehicle. In other embodiments, the vehicle occupant data of 306 includes one or more determinations from the occupant sensors 76 (e.g., by “smart” sensors having a processor or being associated with a processor) as to the number of occupants inside the vehicle. In addition, in various embodiments, the vehicle occupant data of 306 may be part of the vehicle data of 304.

Also in various embodiments, vehicle location data is obtained at 308. In various embodiments, the vehicle location data information as to the geographic location of the vehicle 12 as it travels along a roadway. In various embodiments, the vehicle location data includes geographic coordinates for the vehicle 12 along with map information (e.g., from a computer memory) corresponding to the geographic coordinates, including map information pertaining to regulated roadways (e.g., toll roads, RUC roads, HOV lanes, and roads with designated parking areas) through which the vehicle 12 travels. In addition, in various embodiments, the vehicle location data of 308 may be part of the vehicle data of 304 (e.g., for the vehicle 12 and/or other vehicles, as discussed above).

A determination is made at 310 as to whether the vehicle has entered a geo-fence representing a regulated roadway. In various embodiments, the geo-fence pertains to one or more geographic locations (e.g., using stored map, such as that described above) with respect to one or more regulated roadways (e.g., a toll road, RCE road, road with a designated parking area, or an HOV lane). In certain embodiments, the geo-fence represents one or more boundaries for the regulated roadway, and the vehicle 12 is determined to have entered the geo-fence when the vehicle 12 enters a boundary for the geo-fence (thereby representing entry onto the regulated roadway). In various embodiments, this determination is made by a processor (such as processor 38 of FIG. 1 onboard the vehicle 12) using the vehicle location data of 308.

In addition, a particular type of roadway associated with the geo-fence is identified at 312. In various embodiments, a determination is made as to a type of regulated roadway (e.g., a toll road, RUC road, road having a designated parking area, or HOV lane) pertaining to the geo-fence of 310. Accordingly, in various embodiments, the determination of 312 comprises a determination of the type of regulated roadway (e.g., e.g., a toll road, RUC road, road having a designated parking area, or HOV lane) through which the vehicle 12 is travelling. In various embodiments, this determination is made by a processor (such as processor 38 of FIG. 1 onboard the vehicle 12) using the vehicle location data of 308 and stored map data (for example, using map data stored in the memory 40 of FIG. 1, in certain embodiments).

A notification is provided at 314 with respect to entry into the geo-fence. Specifically, in various embodiments, one or more notifications are provided as to the entry into the geo-fence (and entry into the regulated roadway) and the specific type of regulated roadway in which the vehicle 12 is travelling. For one example, such a notification may provide that “Vehicle is entering a toll road”; “Vehicle is entering a Road Usage Charge (RUC) road”; “Vehicle is in a designated parking area having a fee”; or “Vehicle is entering an HOV lane” (as appropriate), and so on. In various embodiments, audio and/or visual notifications may be provided in this manner via the display 85 of the vehicle 12 and/or the user device 15 of FIG. 1, in accordance with one or more instructions and/or messages provided from the processor 38 of FIG. 1.

In certain embodiments, the notification also provides additional details regarding the regulated roadway, along with any other available alternatives, suggestions, and/or options. For example, in certain embodiments, when a vehicle is about to enter an HOV lane (or a toll road or a pay parking area, or the like), the occupant of the vehicle may receive a notification of the option to travel in the HOV lane via a message and/or other notification. In various embodiments, the occupant may ignore, or select the option to travel in the HOV lane (or other regulated roadway) by interacting with a vehicle interface. For example, in one embodiment, the message may state something along the lines of the following: “you can travel in the HOV lane for a fee of x?”, or based on your routing “you can complete your trip x minutes faster by electing to pay a fee of $x to travel in the HOV lane” (followed by “would you like to do so?”). The occupant can then respond accordingly with his or her preferred course of action.

Data monitoring continues at 316 while the vehicle remains within the geo-fence. Specifically, in various embodiments, the vehicle data of 304 (including the vehicle occupant data of 306 and the vehicle location data of 308 continues to be collected so long as the vehicle 12 is travelling through (or otherwise is remaining within) the regulated roadway, using the GPS system 42 and the occupant sensors 72 of FIG. 1.

A determination is made at 318 as to whether the vehicle has exited the geo-fence for the regulated roadway. In various embodiments, the vehicle 12 is determined to have exited the geo-fence when the vehicle 12 exits a boundary for the geo-fence (thereby representing an exit from the regulated roadway). In various embodiments, this determination is made by a processor (such as processor 38 of FIG. 1 onboard the vehicle 12) using the vehicle location data of 308. Also in various embodiments, this determination is made repeatedly, preferably continuously, as the vehicle 12 is monitored at 316.

If it is determined at 318 that the vehicle is still within the geo-fence (e.g., that the vehicle 12 is still within the boundary of the geo-fence, such that the vehicle 12 is travelling through the regulated roadway), then the process returns to 316, as the vehicle monitoring continues. Conversely, once it is determined in an iteration of 318 that the vehicle has exited the geo-fence (e.g., that the vehicle 12 has exited the boundary of the geo-fence, such that the vehicle 12 is no longer travelling through the regulated roadway), then the process proceeds to 320, described directly below.

During 320, a notification is provided with respect to the exit from the geo-fence. Specifically, in various embodiments, one or more notifications are provided as to the exit from the geo-fence and/or the regulated roadway. For one example, such a notification may provide that “Vehicle is exiting the toll road”; “Vehicle is exiting the RUC road”; “Vehicle is existing the designated parking area having a fee”; or “Vehicle is exiting the HOV lane” (as appropriate), and so on. In various embodiments, audio and/or visual notifications may be provided in this manner via the display 85 of the vehicle 12 and/or the user device 15 of FIG. 1, in accordance with one or more instructions and/or messages provided from the processor 38 of FIG. 1.

Data is transmitted at 320. Specifically, in various embodiments, the vehicle occupant data of 306, the location data of 308, or both (as gathered throughout the vehicle monitoring of 316) are transmitted to a remote server, such as the remote server 18 of FIG. 1. In various embodiments in which the regulated roadway comprises a toll road, the transmission includes data pertaining to a distance that the vehicle 12 has travelled along the toll road, for example for use in calculating a toll fee for the vehicle 12. In addition, in certain embodiments, the transmission includes data pertaining to specific segments and lanes of the toll road through which the vehicle has travelled, for example for use in calculating a toll fee for the vehicle 12 (e.g., as different segments and lanes of the toll road may use different calculations for the associated fees, and so on). In certain embodiments in which the regulated roadway comprises a road usage charge (RUC) road, the transmission may include to a distance that the vehicle 12 has travelled throughout one or more RUC roads (e.g., in certain embodiments, throughout any public roads in states charging RUC road fees). In certain embodiments in which the regulated roadway includes a designated parking area for a roadway in which a fee is involved, the transmission may include data for calculated the parking fee, such as an amount of time that the vehicle 12 has been parked in the designated parking area. In certain embodiments in which the regulated roadway comprises an HOV lane, the transmission includes data as to a number of occupants inside the vehicle 12 as the vehicle 12 was travelling through the HOV lane. In various embodiments, the transmissions are made via the transceiver 35 of FIG. 1 via instructions provided by the processor 36 of FIG. 1.

At 324, an assessment is made as to the vehicle's usage of the regulated roadway. For example, in certain embodiments in which the regulated roadway is a toll road, the assessment may pertain to a distance that the vehicle 12 has travelled along the toll road, specific segments and lanes of the toll road through which the vehicle has travelled, and/or one or more other factors that may influence the fee for travelling through the toll road. In other embodiments in which the roadway comprises an RUC road, the assessment may pertain to a distance travelled along RUC roads (e.g., in any public roads in certain states in which fees are charged for distance travelled on public roads). In other embodiments in which the roadway comprises a designated parking area for a road involving a fee, the assessment may pertain to an amount of time in which the vehicle 12 has been parked in the designated parking area. In other embodiments in which the regulated roadway is an HOV lane, the assessment may pertain to the vehicle 12's travel through the HOV lane, and may also include the number of occupants inside the vehicle 12 during the travel through the HOV lane. In certain embodiments, the assessment is made by the processor 36 onboard the vehicle 12, and the assessment is included as part of the data transmission of 322. In certain other embodiments, raw data (e.g., geographic coordinates and sensor weight measurements) are transmitted by the vehicle 12 at 322, and the assessments of 324 are performed by one or more processors of the remote server 18 (e.g. of the one or more servers 54 thereof).

In certain embodiments, an assessment is made at 326 as to the vehicle's compliance of the regulated roadway. For example, in certain embodiments in which the regulated roadway is an HOV road, the assessment may pertain to whether the vehicle 12 had at least a minimum number of occupants in the vehicle 12 as required by law or other regulation for use of the HOV lane. In certain embodiments, the assessment is made by the processor 36 onboard the vehicle 12, and the assessment is included as part of the data transmission of 322. In certain other embodiments, raw data (e.g., geographic coordinates and sensor weight measurements) are transmitted by the vehicle 12 at 322, and the assessment of 326 is performed by one or more processors of the remote server 18 (e.g. of the one or more servers 54 thereof).

In various embodiments, at 328, one or more fees are determined for the vehicle 12. For example, in certain embodiments in which the regulated roadway is a toll road, the fees may be calculated based on the distance that the vehicle 12 has travelled along the toll road, specific segments and lanes of the toll road through which the vehicle has travelled, and/or one or more other factors that may influence the fee for travelling through the toll road, based on the particular regulations for the regulated roadway at issue (and using the vehicle location data and/or assessments pertaining thereto). In other embodiments in which the roadway comprises an RUC road, the fees may be calculated based on a distance travelled along RUC roads (e.g., in any public roads in certain states in which fees are charged for distance travelled on public roads). In other embodiments in which the roadway comprises a designated parking area for a road involving a fee, the fees may be calculated based on an amount of time in which the vehicle 12 has been parked in the designated parking area. In other embodiments in which the regulated roadway is an HOV lane, the assessment may pertain to a fee associated with travelling on the HOV lane without a sufficient number of occupants inside the vehicle 12, based on local laws and/or regulations (and using the vehicle occupant data and/or assessments pertaining thereto). In certain embodiments, the fees are calculated by the processor 36 onboard the vehicle 12, and in certain embodiments may be included as part of the data transmission of 322. In certain other embodiments, the fees are calculated by the one or more processors of the remote server 18 (e.g. of the one or more servers 54 thereof). It will be further appreciated that in certain circumstances the regulated roadway may be both a toll road and an HOV lane, and therefore both types of fees may apply, and so on. Also, in certain embodiments, similar to the discussion above, fees may be determined for the vehicle 12 based on vehicle data from the vehicle 12 itself and/or in combination with vehicle data from other nearby vehicles (e.g., as estimates of congestion and/or pollution for the roadway, in certain embodiments).

Also in various embodiments, the fees are collected at 330. In certain embodiments, one or more messages are transmitted by the remote server 18 of FIG. 1 to the vehicle 12 and/or the user device 15 of FIG. 1, including an invoice for the fees. Such invoice may appear, for example, on the vehicle display 85 and/or the user device 15 of FIG. 1, and in certain embodiments may also be paid by the user via the vehicle display 85 and/or user device 15. In certain other embodiments, the fees may be collected and/or paid via one or more other means, such as mail, facsimile, and/or other means.

In various embodiments, the process 300 then terminates at 322.

Accordingly, in accordance with various embodiments, methods and systems are provided for dynamic data collection with respect to regulated roadways on which the vehicle travels, from an embedded system that is built into the vehicle. In various embodiments, such methods, systems, and vehicles monitor the vehicle's usage of, and/or compliance with, regulated roadways such as toll roads, RUC roads, roads with designated parking areas, and high occupancy vehicle (HOV) lanes. In various embodiments, the data is transmitted from the vehicle to a remote server for use in calculating and/or collecting fees pertaining to the vehicle's usage of the regulated roadways. In addition, in various embodiments, the fees and compliance are calculated using granular data based on a system with components that are embedded within the vehicle (per the discussions above), thereby providing potentially improved reliability, accuracy, and robustness for the underlying data and the calculated fees.

It will be appreciated that the systems and methods may vary from those depicted in the Figures and described herein. For example, the communications system of FIG. 1, including the remote server, the vehicles, communications networks, and/or components thereof, may vary from that depicted in FIG. 1 and/or described herein, in various embodiments. It will similarly be appreciated that the modules may vary from the depictions in FIG. 2 and the accompanying descriptions. It will also be appreciated that the process (and/or subprocesses) disclosed herein may differ from those described herein and/or depicted in FIG. 3, and/or that steps thereof may be performed simultaneously and/or in a different order as described herein and/or depicted in FIG. 3, among other possible variations.

While at least one example has been presented in the foregoing detailed description, it should be appreciated that a vast number of variations exist. It should also be appreciated that the example or examples are only examples, and are not intended to limit the scope, applicability, or configuration of the disclosure in any way. Rather, the foregoing detailed description will provide those skilled in the art with a convenient road map for implementing the example or examples. It should be understood that various changes can be made in the function and arrangement of elements without departing from the scope of the appended claims and the legal equivalents thereof

What is claimed is:

1. A method comprising:
obtaining location data for a vehicle while the vehicle is travelling, via a positioning system built into the vehicle;
determining when the vehicle has entered a geo-fence associated with a regulated roadway, via a processor built into the vehicle;
monitoring the vehicle, using the processor along with the positioning system, one or more sensors built into the vehicle, or both, generating vehicle data, while the vehicle is within the geo-fence, the vehicle data pertaining to a vehicle's usage of, compliance with, or both, of the regulated roadway;
determining when the vehicle has exited the geo-fence, via the processor disposed onboard the vehicle; and
transmitting the vehicle data, for use in determining a fee associated with the vehicle's travel along the regulated roadway, after the vehicle has exited the geo-fence, via a transceiver disposed onboard the vehicle.

2. The method of claim 1, wherein the positioning system, the one or more sensors, the processor, and the transceiver are built into the vehicle at the time of manufacture of the vehicle.

3. The method of claim 1, wherein the regulated roadway comprises a toll road.

4. The method of claim 3, wherein:
the step of monitoring the vehicle comprises monitoring a distance within the toll road through which the vehicle has travelled, using data from the positioning system.

5. The method of claim 3, wherein:
the step of monitoring the vehicle comprises monitoring specific segments and lanes of the toll road through which the vehicle has travelled, using data from the positioning system.

6. The method of claim 1, wherein:
the regulated roadway includes a high occupancy vehicle (HOV) lane; and
the step of monitoring the vehicle comprises monitoring a number of occupants in the vehicle as the vehicle travels through the HOV lane, using data from the one or more sensors.

7. The method of claim 1, wherein the regulated roadway comprises road usage charge (RUC) road.

8. The method of claim 1, wherein the regulated roadway comprises a roadway having a designated parking area.

9. The method of claim 1, further comprising:
determining a monetary fee associated with the vehicle's travelling through the roadway, based on the vehicle's usage of, compliance with, or both, with respect to the regulated roadway, using the vehicle data, data from one or more other nearby vehicles, or both.

10. The method of claim 1, further comprising:
determining a classification for the regulated roadway; and
providing a notification, for an occupant inside the vehicle, of the classification of the regulated roadway when the vehicle enters and exits the geo-fence.

11. A vehicle system comprising:
a positioning system disposed onboard a vehicle and configured to obtain location data for the vehicle while the vehicle is travelling;
one or more sensors built into the vehicle;
a processor disposed onboard the vehicle and configured to:
determine when the vehicle has entered a geo-fence associated with a regulated roadway, via a processor disposed onboard the vehicle;
monitor the vehicle, using the processor along with the positioning system, the one or more sensors, or both, generating vehicle data, while the vehicle is within the geo-fence, the vehicle data pertaining to a vehicle's usage of, compliance with, or both, of the regulated roadway;
determine when the vehicle has exited the geo-fence, via the processor disposed onboard the vehicle; and
provide instructions for transmitting the vehicle data, for use in determining a fee associated with the vehicle's travel along the regulated roadway, after the vehicle has exited the geo-fence; and
a transceiver built into the vehicle and configured to transmit the vehicle data, for use in determining a fee associated with the vehicle's travel along the regulated roadway, after the vehicle has exited the geo-fence, in accordance with the instructions provided by the processor.

12. The vehicle system of claim 11, wherein the positioning system, the one or more sensors, the processor, and the transceiver are built into the vehicle at the time of manufacture of the vehicle.

13. The vehicle system of claim 11, wherein the regulated roadway comprises a toll road, and the processor is configured to monitor the vehicle by monitoring a distance within the toll road through which the vehicle has travelled, using data from the positioning system.

14. The vehicle system of claim 11, wherein the regulated roadway comprises a toll road, and the processor is configured to monitor the vehicle by monitoring specific segments and lanes of the toll road through which the vehicle has travelled, using data from the positioning system.

15. The vehicle system of claim 11, wherein:
the regulated roadway includes a high occupancy vehicle (HOV) lane; and
the processor is configured to monitor the vehicle by monitoring a number of occupants in the vehicle as the vehicle travels through the HOV lane, using data from the one or more sensors.

16. The vehicle system of claim 11, wherein the processor is configured to determine a monetary fee associated with the vehicle's travelling through the roadway, based on the vehicle's usage of, compliance with, or both, with respect to the regulated roadway, using the vehicle data, data from one or more other nearby vehicles, or both.

17. The vehicle system of claim 11, wherein the processor is configured to:
determine a classification for the regulated roadway; and
provide a notification, for an occupant inside the vehicle, of the classification of the regulated roadway when the vehicle enters and exits the geo-fence.

18. A communication system comprising:
a positioning system disposed onboard a vehicle and configured to obtain location data for the vehicle while the vehicle is travelling;
one or more sensors built into the vehicle;
a first processor disposed onboard the vehicle and configured to:
determine when the vehicle has entered a geo-fence associated with a regulated roadway, via a processor disposed onboard the vehicle;
monitor the vehicle, using the processor along with the positioning system, the one or more sensors, or both, generating vehicle data, while the vehicle is within the geo-fence, the vehicle data pertaining to a vehicle's usage of, compliance with, or both, of the regulated roadway;
determine when the vehicle has exited the geo-fence, via the processor disposed onboard the vehicle; and
provide instructions for transmitting the vehicle data, for use in determining a fee associated with the vehicle's travel along the regulated roadway, after the vehicle has exited the geo-fence;
a transceiver built into the vehicle and configured to transmit the vehicle data, after the vehicle has exited the geo-fence, in accordance with the instructions provided by the processor; and
a second processor disposed remote from the vehicle, the second processor configured to:
determine the vehicle's usage, compliance, or both, of the regulated roadway, using the vehicle data; and
determine a monetary fee associated with the vehicle's travel along the regulated roadway, based on the vehicle's usage, compliance, or both, of the regulated roadway using the vehicle data.

19. The communication system of claim 18, wherein:
the regulated roadway comprises a toll road;
the vehicle data comprises specific segments and lanes of the toll road through which the vehicle has travelled, as determined using information from the positioning system; and
the second processor is configured to determine the monetary fee based on the specific segments and lanes of the toll road through which the vehicle has travelled.

20. The communication system of claim 18, wherein:
the regulated roadway comprises a high occupancy (HOV) lane;
the vehicle data comprises a number of occupants in the vehicle, as determined using information from the one or more sensors; and
the second processor is configured to determine the monetary fee based on the number of occupants in the vehicle as the vehicle travels through the high occupancy lane.
